(19) United States
(12) Patent Application Publication
(10) Pub. No.: US 2008/0016573 A1
(43) Pub. Date: Jan. 17, 2008

(54) Method for detecting computer viruses

(75) Inventor: Alexey Lyashko, Haifa (IL)

Correspondence Address: DR. MARK FRIEDMAN LTD.;c/o Bill Polkinghorn, 9003 Florin Way, Upper Marlboro, MD, 20772, US

(73) Assignee: ALADDIN KNOWLEDGE SYSTEM LTD.

(21) Appl. No.: 11/485,380

(22) Filed: Jul. 13, 2006

(51) Int. Cl. G06F 12/14

(52) U.S. Cl. 726/24

(57) ABSTRACT

The present invention is directed to a method for characterizing a virus. The method comprises the steps of: detecting a viral part of an infected computer program; obtaining the profiles of at least one programming instruction of the viral part, a profile is a symbol representing generic information of respective programming instruction(s) thereof; and composing a string from the obtained profiles for identifying the viral part on another program, thereby characterizing the virus by the string from the obtained profiles.

### FIELD OF THE INVENTION

The present invention relates to the field of virus signature. More particularly, the invention relates to an improved method for detecting a computer virus by virus signature, which can be used also for polymorphic viruses.

### BACKGROUND OF THE INVENTION

Wikipedia, The Free Encyclopedia, defines the term “Virus Signature” as “a unique string of bits, or the binary pattern, of all or part of a computer virus. The virus signature is like a fingerprint in that it can be used to detect and identify specific viruses. Anti-virus software uses the virus signature to scan for the presence of malicious code.” (Retrieved from “http://en.wikipedia.org/wiki/Virus_signature”)

One of the approaches for identifying computer viruses is known as the “Virus Directory”. According to this approach, a virus directory (i.e., a list) is used for storing known characteristics of known viruses, especially the virus signature. When antivirus software examines a file, it refers to a dictionary (i.e., a list) of known viruses that already have been identified. If a piece of code in the file matches any virus identified in the dictionary, then the antivirus software can, for example, repair the file by removing the virus itself from the file, quarantine the file (such that the file remains inaccessible to other programs and its virus can no longer spread), or even delete the infected file.

In order to characterize a virus, an infected file has to be tested in an antivirus laboratory, in order to detect the sequence that characterizes the virus, i.e. the virus signature. Once a virus is identified, its signature is propagated to the antivirus directory of users. Virus authors have tried to stay a step ahead of antivirus manufacturers by writing “polymorphic” viruses, i.e. viruses which have different code, but ultimately perform the same operation. This way identifying one virus does not help to identify another virus of the same “family”.

The objects and advantages of the invention will become apparent as the description proceeds.

### SUMMARY OF THE INVENTION

In one aspect, the present invention is directed to a method for characterizing a virus, the method comprising the steps of:
detecting a viral part of an infected computer program;
obtaining the profiles of at least one programming instruction of the viral part, wherein each the profiles is a symbol representing generic information of respective one or more programming instructions thereof; and
composing a string from the obtained profiles for identifying the viral part, thereby characterizing the virus by the string from the obtained profiles.

In another aspect the present invention is directed to method for identifying an infected computer program, the method comprising the steps of:
composing a string from profiles of a viral part of at least one infected computer program, wherein each the profile is a symbol representing generic information of respective one or more programming instructions thereof;
searching the string in a database of virus profiles; and
identifying the computer program as infected by the virus if the string is found in the searching.

In yet another aspect, the present invention is directed to a method for characterizing a malicious digital object, the method comprising the steps of:
detecting a malicious part of a malicious digital object;
obtaining the profiles of at least one programming instruction of the malicious part, wherein each the profiles is a symbol representing generic information of respective one or more instructions thereof; and
composing a string characterizing the malicious part from the obtained profiles.

In yet another aspect, the present invention is directed to a method for detecting a malicious digital object, the method comprising the steps of:
composing a string from profiles of a malicious digital object, wherein each the profiles is a symbol representing generic information of respective one or more programming instructions thereof;
searching the string in a database of profiles of malicious digital objects; and
identifying the suspected digital object as malicious if the string is found in the profiles of the searching.

In yet another aspect, the present invention is directed to a computer readable medium comprising program instructions, wherein when executed the program instructions are operable to:
detect a viral part of an infected computer program;
obtain the profile of at least one instruction of the viral part, wherein the profile is a symbol representing generic information of the instruction thereof; and
obtaining a string characterizing the viral part from the obtained profiles.

The viral part and the malicious part may comprise any type of code, including but not limited to compiled code, human readable code, and intermediate code (binary-like code but not necessary compiled code such as Java class, to script languages such as VBScript, etc.)

The generic information of a symbol may represent one or more opcodes, or one or more opcodes and the type of the operand(s) thereof, etc.

The step of searching a string in profiles may be carried out at a “filtering facility”, i.e. a computerized machine, which performs anti-virus or anti-malicious operations. Examples of a filtering facility may be a user's computer, a gateway server to a network (e.g. eSafe appliance, manufactured by the applicant of the present invention), a server of an Internet Service Provider, a web server, a mail server, etc.

### BRIEF DESCRIPTION OF THE DRAWINGS

The present invention may be better understood in conjunction with the following figures:

FIG. 1 illustrates two examples of programming code, according to the prior art.

FIG. 2 illustrates the profile of the programming instructions of the examples of FIG. 1, according to a preferred embodiment of the invention.

FIG. 3 illustrates the profile of the programming instructions of the examples of FIG. 1, according to a preferred embodiment of the invention.

FIG. 4 is a flowchart of a method for characterizing a computer virus, and detecting infected programs using the characterization of the virus, according to a preferred embodiment of the invention.

### DETAILED DESCRIPTION OF PREFERRED EMBODIMENTS

In order to facilitate understanding the examples herein, the examples are presented in assembler programming language, but it should be understood that the invention can be applied as well on a machine code. Furthermore, the invention may be applied also to high-level programming languages such as C and Pascal, to “intermediate” code, i.e. binary-like code but not necessary compiled code such as Java class, to script languages such as VBScript, etc.

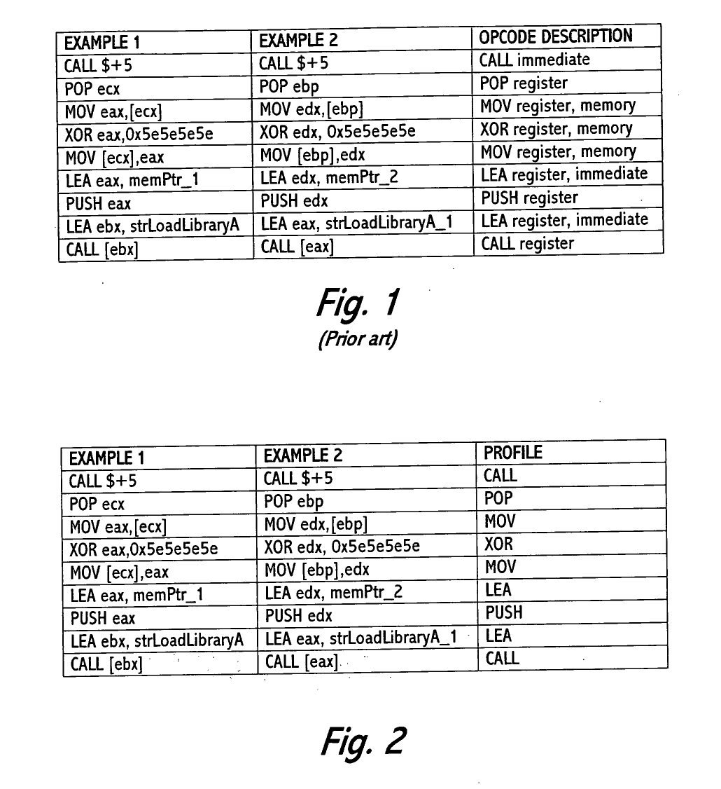

FIG. 1 illustrates two examples of programming code, Example 1 and Example 2, according to the prior art. Although the code of Example 1 differs than the code of Example 2, both examples perform the same operation.

### Profile of a Programming Instruction

The term “profile of a programming instruction” refers herein to a symbol which represents generic information of the programming instruction.

The term “profile of a plurality of programming instructions” refers herein to a symbol which represents generic information of the programming instructions. Thus, in this case one symbol represents a plurality of programming instructions.

The term “generic” implies that a profile of a programming instruction comprises only partial information of the programming instruction.

For example, the ASM instruction “CALL $+5” can be presented by a profile in different ways: “CALL_IMMEDIATE”, just “CALL”, etc. In both examples the profile provides only partial information of the original ASM instruction.

FIG. 2 illustrates the profile of the programming instructions of the examples of FIG. 1, according to a preferred embodiment of the invention. In this case, the profile of each programming instruction is its opcode. For example, the profile of the instruction “MOV [ecx],eax” is “MOV”.

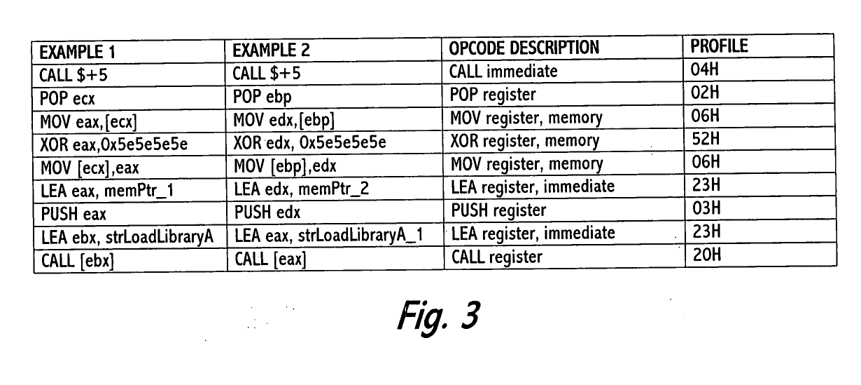

FIG. 3 illustrates the profile of the programming instructions of the examples of FIG. 1, according to a preferred embodiment of the invention. In this case, the profile of each programming instruction is a code which represents the meaning of the instruction. For example, the meaning of the instruction “MOV [ecx],eax” is “MOV register, memory”, and the profile of the instruction is the value 06H.

For example, referring to FIG. 3, the profile of the programming code of this figure is the string “04 02 06 52 06 23 03 23 20H”. The string is actually a “signature” of profiles, but it differs from the signature of a virus by the fact that the signature obtained from profiles comprises generic information (in contrast to a signature of a virus which comprises specific information to the virus thereof). As comprising generic information, a “profile signature” may suit to a plurality of programs generated by the same source, such as polymorphic viruses (in contrast to a signature of a virus which suits to a specific virus).

According to one embodiment of the invention, a profile consists of, for example, a 16 bit word, where bits 4-15 represent an opcode (e.g. “MOV”, “ADD”, “XOR”, etc.) and bits 0-3 represent the types of its operands, regardless of their order within the original command.

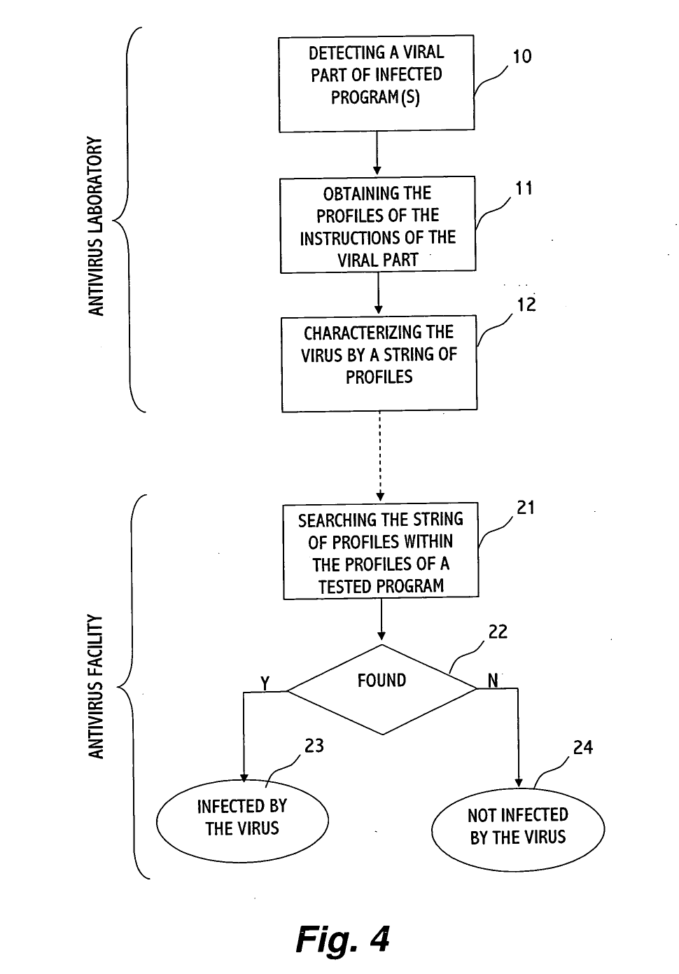

FIG. 4 is a flowchart of a method for characterizing a computer virus, and detecting infected programs using the characterization of the virus, according to a preferred embodiment of the invention.

Blocks 10 to 12 are carried out at an antivirus laboratory, while blocks 21 to 24 are carried out at an antivirus facility, such as antivirus program at the user's computer, a gateway to a local area network, an ISP (Internet Service Provider), a mail server, etc.

At block 10, the viral part of one or more programs infected by the same virus is detected. This step, which usually is carried out in an antivirus lab, is well known in the art. For example, infected files are monitored step by step in order to detect their viral part.

At block 11, the profiles of the instructions of the viral part are obtained from the instructions of the viral part.

At block 12, the viral part is characterized by a string of the obtained profiles. The string does not necessarily have to include the profiles of all the viral part, but only a part of it. As shorter the string, as faster the search of the string in the profiles of a tested program.

At block 21, which is carried out at an antivirus facility, the string that characterizes the virus is searched in the profiles of a tested program.

At block 22, if the string has been found, then the program is infected by the virus characterized by the string (block 23), otherwise, the program probably is not infected by this virus (block 24), but of course can be infected by other viruses.

Actually, the search is not necessarily for a specific virus, but in exemplary embodiments, the search is for a plurality of viruses, each characterized by a unique “profiles signature”, as in the Virus Directory approach described hereinabove. Those skilled in the art will appreciate that this part is well known in the art, and a variety of methods are used for speeding up the search process.

In research carried out by Aladdin Knowledge Systems Ltd., the applicant of the present invention, it has been found that using two or more “representatives” of a virus family provides a “profile signature”, resulting in far fewer false positives than in any other virus detection method.

It should be noted that the method applies to both compiled code, such as EXE files, and human readable code, such as a scripting language.

It should also be noted that the term “virus” refers to any form of a malicious object, including spyware, Trojan horses, unwanted web content (e.g. pornographic), malicious scripts, and so forth. Actually, a malicious object may be also a multimedia file. For example, a multimedia file may be infected by an exploitive executable code. In case of a WMF multimedia file exploit an infected file contains a corrupted record which, when parsed, forces the viewer application to jump into executable code stored within the file. By applying the present invention on this executable code, it is possible to determine whether the file is infected.

In the description and claims of the present application, each of the verbs, “comprise” “include” and “have”, and conjugates thereof, are used to indicate that the object or objects of the verb are not necessarily a complete listing of members, components, elements or parts of the subject or subjects of the verb.

All references cited herein are incorporated by reference in their entirety. Citation of a reference does not constitute an admission that the reference is prior art.

The articles “a” and “an” are used herein to refer to one or to more than one (i.e., to at least one) of the grammatical object of the article. By way of example, “an element” means one element or more than one element. The term “including” is used herein to mean, and is used interchangeably with, the phrase “including but not limited” to.

The term “or” is used herein to mean, and is used interchangeably with, the term “and/or,” unless context clearly indicates otherwise.

The term “such as” is used herein to mean, and is used interchangeably, with the phrase “such as but not limited to”.

Those skilled in the art will appreciate that the invention can be embodied in other forms and ways, without losing the scope of the invention. The embodiments described herein should be considered as illustrative and not restrictive.

1. A method for characterizing a virus, the method comprising the steps of:
detecting a viral part of an infected computer program;
obtaining the profiles of at least one programming instruction of said viral part, wherein each said profiles is a symbol representing generic information of respective one or more instructions thereof; and
composing a string from the obtained profile for identifying said viral part, thereby characterizing said virus by said string from the obtained profiles.

2. A method according to claim 1, wherein said viral part comprises a compiled code.

3. A method according to claim 1, wherein said viral part comprises human readable code.

4. A method according to claim 1, wherein said viral part comprises intermediate code.

5. A method according to claim 1, wherein at least one said generic information comprises at least one opcode.

6. A method according to claim 1, wherein at least one said generic information comprises at least one opcode and the type of the operand(s) thereof.

7. A method for identifying an infected computer program, the method comprising the steps of:
composing a string from profiles of a viral part of at least one infected computer program, wherein each said profile is a symbol representing generic information of respective one or more programming instructions thereof;
searching said string in a database of virus profiles; and
identifying said computer program as infected by said virus if said string is found in said searching.

8. A method according to claim 7, wherein said computer program comprises compiled code.

9. A method according to claim 7, wherein said computer program comprises human readable code.

10. A method according to claim 7, wherein said viral part comprises intermediate code.

11. A method according to claim 7, wherein said step of searching a string in profiles is carried out at a filtering facility.

12. A method for characterizing a malicious digital object, the method comprising the steps of:
detecting a malicious part of a malicious digital object;
obtaining the profiles of at least one programming instruction of said malicious part, wherein each said profile is a symbol representing generic information of respective one or more instructions thereof; and
composing a string characterizing said malicious part from the obtained profiles.

13. A method according to claim 12, wherein said malicious part comprises a compiled code.

14. A method according to claim 12, wherein said malicious part comprises human readable code.

15. A method according to claim 12, wherein at least one said symbol represents an executable instruction.

16. A method according to claim 12, wherein at least one said symbol represents an executable instruction and the type of the operand(s) thereof.

17. A method for detecting a malicious digital object, the method comprising the steps of:
composing a string from profiles of a malicious digital object, wherein each said profiles is a symbol representing generic information of respective one or more programming instructions thereof;
searching said string in a database of profiles of malicious digital objects; and
identifying said suspected digital object as malicious if said string is found in said searching.

18. A method according to claim 17, wherein said malicious object comprises compiled code.

19. A method according to claim 17, wherein said malicious object comprises human readable code.

20. A method according to claim 17, wherein said step of searching a string in profiles is carried out at a filtering facility.

21. A computer readable medium comprising program instructions, wherein when executed the program instructions are operable to:
detect a viral part of an infected computer program;
obtain the profile of at least one instruction of said viral part, wherein said profile is a symbol representing generic information of the instruction thereof, and
obtaining a string characterizing said viral part from the obtained profiles.
